(19) United States
(12) Patent Application Publication
(10) Pub. No.: US 2022/0050693 A1
(43) Pub. Date: Feb. 17, 2022

(54) DETERMINE STEP POSITION TO OFFER USER ASSISTANCE ON AN AUGMENTED REALITY SYSTEM

(71) Applicant: INTERNATIONAL BUSINESS MACHINES CORPORATION, Armonk, NY (US)

(72) Inventors: Robin Yehle Bobbitt, Raleigh, NC (US); Nicholas Tsang, Saratoga, CA (US); Tammy Rose Cornell, Wake Forest, NC (US); Daniel Botero Lopez, Venice, CA (US); Thomas Reinecke, Freiberg (DE)

(21) Appl. No.: 16/990,546

(22) Filed: Aug. 11, 2020

(51) Int. Cl. G06F 9/451; H04L 29/06; G06T 19/00

(52) U.S. Cl. CPC G06F 9/453; G06T 19/006; H04L 67/40

(57) ABSTRACT

According to one embodiment, a method, computer system, and computer program product for providing support to a user within an augmented reality environment based on an emotional state of the user is provided. The present invention may include based on data gathered from an augmented reality device, determining a step of a series of steps the user is currently performing, identifying the current emotional state of the user based at least in part on data gathered from the augmented reality device, responsive to determining that the current emotional state of the user is frustrated, performing one or more actions to reduce the frustration of the user; and responsive to determining that the current emotional state of the user is frustrated or confused, performing one or more support actions to assist the user in completing the step based on the current emotional state of the user.

### BACKGROUND

The present invention relates, generally, to the field of computing, and more particularly to augmented reality.

Augmented reality (AR) is a modern computing technology that uses software to generate images, sounds, haptic feedback, and other sensations to augment a real-world environment. While the creation of this augmented environment can be achieved with general-purpose computing devices, such as cell phones, more specialized equipment is also used, typically in the form of glasses or headsets where computer generated elements are overlaid onto a view of the real world by being projected or mapped onto a lens in front of a user's eyes. With the help of computer augmentation, information about the surrounding world of the user, as well as other digital elements overlaid onto the world, become interactive and digitally manipulable. This technology has the potential to transform countless aspects of human life, from construction to military training to space exploration.

### SUMMARY

According to one embodiment, a method, computer system, and computer program product for providing support to a user within an augmented reality environment based on an emotional state of the user is provided. The present invention may include based on data gathered from an augmented reality device, determining a step of a series of steps the user is currently performing, identifying the current emotional state of the user based at least in part on data gathered from the augmented reality device, responsive to determining that the current emotional state of the user is frustrated and/or confused, performing one or more actions to reduce the frustration of the user; and responsive to determining that the current emotional state of the user is frustrated or confused, performing one or more support actions to assist the user in completing the step based on the current emotional state of the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a augmented reality assistance process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to augmented reality. The following described exemplary embodiments provide a system, method, and program product to, among other things, utilize audio and visual data from an augmented reality system to assess the emotional condition of the user, the user's current progress in executing a task, the reasons for the user's difficulty, and formulate an appropriate support response. Therefore, the present embodiment has the capacity to improve the technical field of augmented reality by providing assistance that is tailored to the user's emotional state and the nature of the user's difficulty, thereby minimizing frustration, increasing the helpfulness of the assistance, and increasing the speed with which a user can overcome frustrating or confusing steps and achieve the embarked-upon task.

As previously described, augmented reality (AR) is a modern computing technology that uses software to generate images, sounds, haptic feedback, and other sensations to augment a real-world environment. While the creation of this augmented environment can be achieved with general-purpose computing devices, such as cell phones, more specialized equipment is also used, typically in the form of glasses or headsets where computer generated elements are overlaid onto a view of the real world by being projected or mapped onto a lens in front of a user's eyes. With the help of computer augmentation, information about the surrounding world of the user, as well as other digital elements overlaid onto the world, become interactive and digitally manipulable. This technology has the potential to transform countless aspects of human life, from construction to military training to space exploration.

One such context where augmented reality is poised to make a significant impact is in user assistance; in any situation where a user has to carry out a series of steps to execute a task, be that building a piece of furniture, assembling a computer, baking a cake, et cetera, augmented reality stands to provide a beneficial impact by providing users auditory assistance accompanied by visual overlays. However, in all contexts where a user is executing a particularly tricky task and desires assistance, there is the potential that a user may be experiencing a spectrum of emotions such as frustration, confusion, anger, et cetera. Attempts to assist the user may be poorly received or even counterproductive if the emotions of the user, and the context and/or reasons for those emotions, are not taken into account when formulating a response. For example, if a user is frustrated when performing a step in assembling a new grill because the user has been repeatedly attempting to connect a part with no success, telling the user to connect the part without elaboration or addressing what the user is doing wrong may not only prove unhelpful, but may anger the user. Asking the user to provide context or explain the problem may also be counterproductive, as the process of repeating the steps performed or bringing a live human support agent or automated support system up to speed may seem time consuming and laborious to a user, causing further frustration. As such, it may be advantageous to, among other things, implement a system that uses audio and video from an augmented reality system to determine the current progress of a user in executing a task, identifies the emotions of the user with relation to the task or other external factors, assesses the context of the user's emotions and current difficulty, and formulates support responses based on the user's emotions and context.

According to one embodiment, the invention is a system, method, and/or computer program product for utilizing data from an augmented reality device to analyze a user's behavior, identify a user's emotional state based on the analyzed behavior, identify possible reasons for a user's emotional state, identify the current context of the user's progress within the task, and formulate a support response based on the possible reasons, context, and emotional state.

In some embodiments of the invention, the system may assess the level of frustration of a user, and take action to reduce the user's frustration and to assist the user based on the assessed level of frustration. For example, if the user is a little bit frustrated, the system may make the AR environment more friendly, perhaps by adding cartoon characters or more calming colors, gentler voices or more polite tones. On the other hand, if the user is extremely frustrated, the system may try and calm the user down by suggesting a break, acknowledging the user's frustration and the difficulty of the task, et cetera.

In some embodiments of the invention, the system may record which actions helped reduce confusion and/or frustration for a user, and which actions increased confusion and/or frustration for a user within a particular context, so that the system may avoid performing those actions in the same or similar context in the future.

In some embodiments of the invention, the system determines the level of difficulty of a task or steps for a specific user based on the steps or elements of the steps the user found confusing or frustrating. The system may store this information in a user profile, and may further store all information pertaining to steps that a user found confusing or frustrating, including how the user expressed confusion or frustration, what amount of confusion or frustration was caused by environmental factors external to the instructions or AR elements of the step itself, et cetera, such that the system may be able to identify which steps or elements of a step cause trouble for the user, utilize machine learning to improve how accurately the system identifies frustration or confusion within a particular user or within a class or set of users. The system may further use the steps that the user found confusing or frustrating in combination with information about the user to make general inferences regarding which classes of users find which steps, step elements, or types of steps or types of step elements difficult.

In some embodiments of the invention, the system may generate a model based on the number and classes of users which have common issues over certain steps, so that the model can be used to inform updates for the steps. For example, if a number of users exceeding a threshold number or percentage encounter a common issue at a certain step, the system may recommend that the description be elaborated upon, or that the augmented reality information accompanying the step be improved, for example to include metadata or various new angles.

In some embodiments of the invention, the system may visually represent the elements of the step that cause confusion and/or frustration in a user within the AR environment, so that a support agent may quickly assess the trouble elements of the user. For example, the system may apply a heatmap within the AR environment that highlights trouble elements or objects pertaining to trouble elements in red. The system may also highlight instructions that caused trouble.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to utilize audio and visual data from an augmented reality system to assess the emotional condition of the user, the user's current progress in executing a task, the reasons for the user's difficulty, and formulate an appropriate support response.

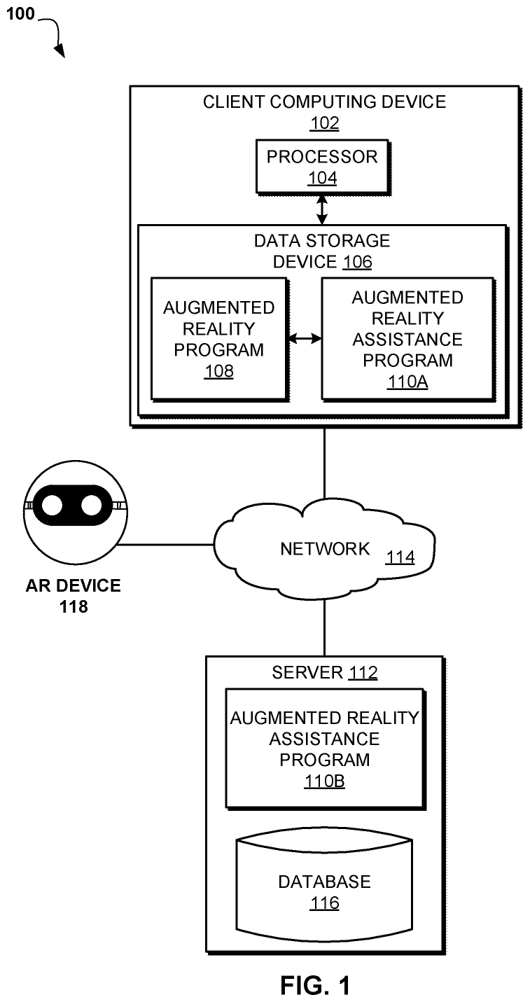

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

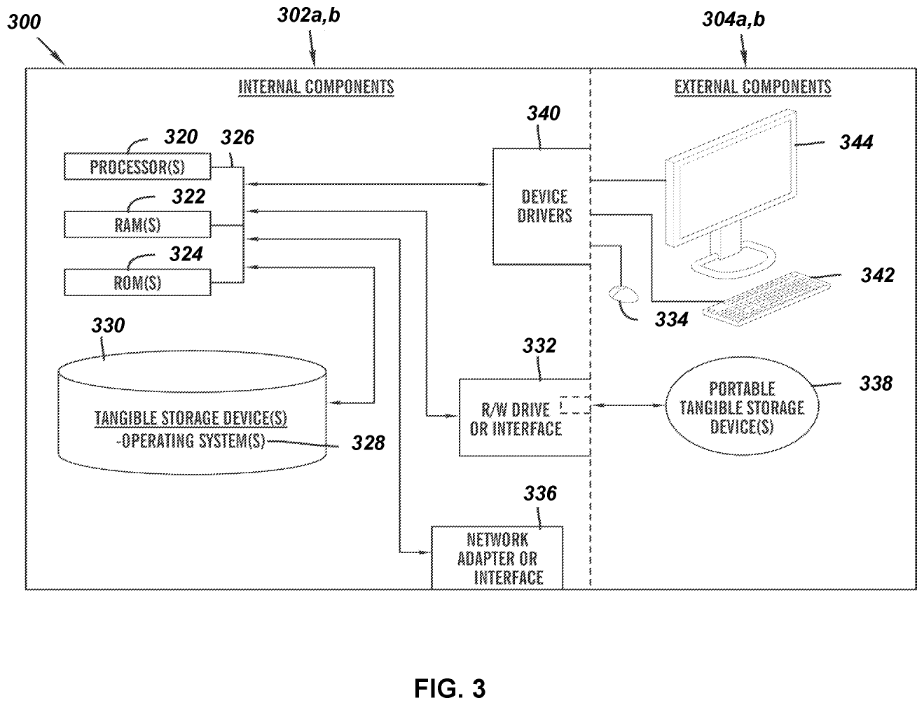

Client computing device 102 may include a processor 104 and a data storage device 106 that is enabled to host and run an augmented reality program 108 and an augmented reality assistance program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

Augmented reality program 108 may be any program capable of enhancing real-world environments and/or objects with computer-generated perceptual information, such as visual, auditory, haptic, et cetera. Augmented reality program 108 may accurately register both physical and virtual objects within the physical world, such that virtual elements are anchored to a physical location. Augmented reality program 108 may interweave virtual elements into the physical world in real time such that the virtual elements are perceived to be immersive elements of the real world. Augmented reality program 108 may comprise mixed reality and/or computer mediated reality. Augmented reality program 108 may run on AR Device 118, client computing device 102, or server 112, or may be distributed in its operation among any combination of devices in communication directly and/or over network 114.

The server computer 112 may be a laptop computer, netbook computer, personal computer (PC), a desktop computer, or any programmable electronic device or any network of programmable electronic devices capable of hosting and running a augmented reality assistance program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

The Augmented Reality (AR) Device 118 may be any device or combination of devices enabled to record real-world information that Augmented Reality Program 108 may overlay with computer-generated perceptual elements to create an augmented reality environment for the user. Augmented Reality (AR) Device 118 may be equipped with or comprise a number of sensors such as a camera, microphone, accelerometer, et cetera, and/or may be equipped with or comprise a number of user interface devices such as displays, touchscreens, speakers, et cetera. In some embodiments, the AR device 118 may be a headset that is worn by the viewer; in some embodiments, the client computing device 102 may be an AR device 118.

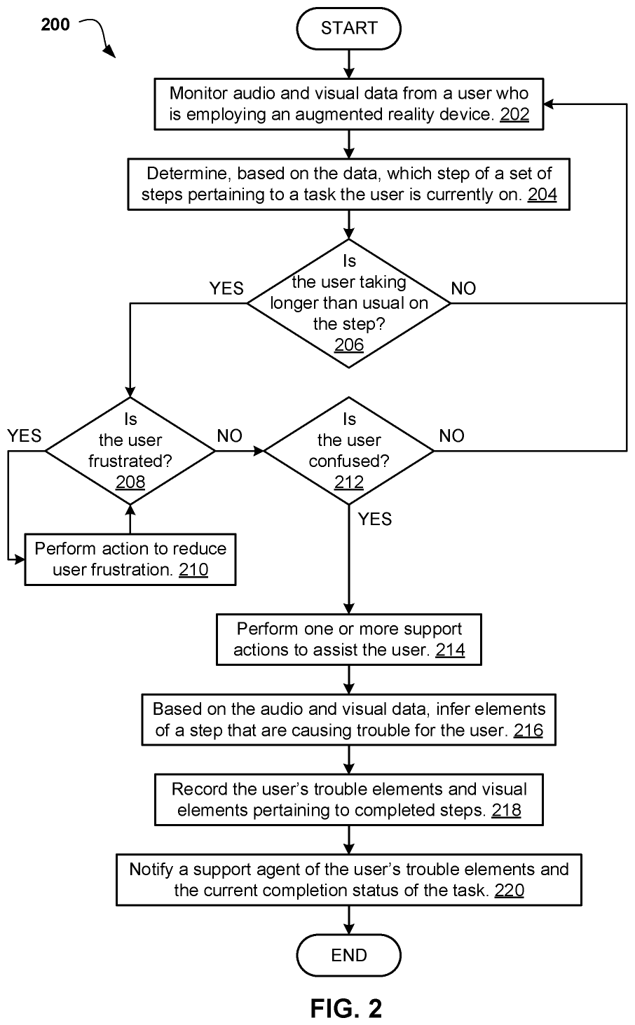

According to the present embodiment, the augmented reality assistance program 110A, 110B may be a program enabled to utilize audio and visual data from an augmented reality system to assess the emotional condition of the user, the user's current progress in executing a task, the reasons for the user's difficulty, and formulate an appropriate support response. The augmented reality assistance program 110A, 110B may be located on client computing device 102 or server 112 or on any other device located within network 114. Furthermore, augmented reality assistance program 110A, 110B may be distributed in its operation over multiple devices, such as client computing device 102 and server 112. augmented reality assistance program 110A, 110B may be a subroutine of, called by, integrated with, or otherwise in communication and/or associated with Augmented Reality Program 108. The augmented reality assistance method is explained in further detail below with respect to FIG. 2.

Referring now to FIG. 2, an operational flowchart illustrating an augmented reality assistance process 200 is depicted according to at least one embodiment. At 202, the augmented reality assistance program 110A, 110B monitors audio and visual data from a user who is employing an augmented reality device 118. The visual data may include a real-time camera feed, which may indicate what the user is looking at. The audio data may include sounds gathered from a microphone, for example one within augmented reality device 118, that may include what the user is saying, background noise, et cetera. The augmented reality assistance program 110A, 110B may use established object detection methods to process the visual data and identify objects relevant to the task that the user is performing, and/or to specific steps of the task. The task may be a process for achieving a goal that is broken down into a series of discrete sub-tasks, or steps, which when performed in a particular order may complete the task and achieve the goal. Objects relevant to a task may, for example, include tools that the user must use to perform an action required by the task, components of a device which must be combined, attached, interacted with to complete the task, ingredients for a dish that must be added or processed, et cetera. For example, if the user is putting together a table, the augmented reality assistance program 110A, 110B may identify the parts of the table among the objects lying on the ground or partially assembled in front of the user, and access a digital instruction manual pertaining to assembly of the table to match each part with a step.

In some embodiments, the augmented reality assistance program 110A, 110B may be provided with a list of objects associated with the task; after utilizing established object detection methods to identify one or more objects within the visual data, the augmented reality assistance program 110A, 110B may match each detected object against the provided list of relevant objects, and any detected object that matches an object in the list may be considered a relevant object. The augmented reality assistance program 110A, 110B may note when a user is interacting with a particular object, and may record which objects have been interacted with, the nature of the interaction, the duration, et cetera. The augmented reality assistance program 110A, 110B may employ speech processing techniques to identify the presence or absence of human speech in the audio, and may further identify a voice as pertaining to a person by matching detected voices against a database of known voices identified as belong to a particular person. In some embodiments, the augmented reality assistance program 110A, 110B may additionally access recorded data, and may perform visual and audio processing on the recorded data.

At 204, the augmented reality assistance program 110A, 110B may determine, based on the data, which step of a task comprising a set of steps pertaining to a task the user is currently on. In some embodiments, the augmented reality assistance program 110A, 110B may receive a description of the task and the set of steps comprising the task. The augmented reality assistance program 110A, 110B may identify an object that the user is currently working on, such as an engine, a bowl of cake batter, a piece of furniture, et cetera, for example by measuring the distance between the user and the object, identifying whether the object is moving relative to the motion of the user, whether an item held by the user such as a tool or component is close to or interacting with the object, et cetera. In some embodiments, for example where the description of the task includes what an object being worked on looks like at each step, the augmented reality assistance program 110A, 110B may further infer which steps have already been performed based on the state of completion of that object based on matching the appearance of the object against the provided objects in the description, and if the object visually matches an object in the description, identifying the particular step in the description corresponding to that object. For example, if a table that the user is working on has a tabletop, braces, and three legs attached, augmented reality assistance program 110A, 110B may infer that all steps except the final step of attaching the fourth leg have been completed. In another example, if the cake batter is of a particular consistency and yellow color, augmented reality assistance program 110A, 110B may infer that eggs and sugar have been added, but cocoa has not, and thereby infer which step the user is currently on. The augmented reality assistance program 110A, 110B may use information about objects the user has interacted with that has been extracted from the visual data, such as which object, whether that object pertains to a certain step, its interaction with other objects, et cetera, to identify whether the user has interacted with objects in accordance with earlier steps, and thereby infer which step the user hasn't completed. For example, if the task is to weather-proof a bench, the steps may comprise sanding the bench, cleaning the bench, and applying sealant to the bench. If the user has interacted with a sander and a rag, and has moved those objects to the immediate proximity the bench, but has not interacted with the brush, augmented reality assistance program 110A, 110B may infer that the sanding and cleaning steps have been performed, but the step of applying finish has not, and is therefore likely to be the step that the user is currently on.

At 206, the augmented reality assistance program 110A, 110B determines whether the user is taking longer than usual on the step. Once identifying the step that the user is on, augmented reality assistance program 110A, 110B may record the amount of time that the user has spent on the step. The augmented reality assistance program 110A, 110B may mark the point in time at which the user had accomplished the previous step, and begin recording from this point. The augmented reality assistance program 110A, 110B may access recorded data regarding the average amount of time that the user has spent on similar steps, for instance steps that augmented reality assistance program 110A, 110B has determined to be of similar difficulty, similar complexity, et cetera. In some embodiments, augmented reality assistance program 110A, 110B may access recorded statistics regarding the average time it has taken other users to complete this particular step, and/or the time it has taken other users to complete similar steps. In some embodiments, augmented reality assistance program 110A, 110B may compare the user's time against the average times of other users who are similar to the user in some way and whose performance at a given step could be comparable to that of the user; for example, users of similar ages, similar levels of familiarity with the task as evidenced by profession, hobbies, past tasks completed, et cetera. According to one implementation, if the augmented reality assistance program 110A, 110B determines that the amount of time that the monitored user is spending on the step exceeds the average amount of time spent on this step, with respect to the user's past performance on similar steps and/or with respect to the amount of time spent by other users on this step or similar steps (step 206, “YES” branch), the augmented reality assistance program 110A, 110B may continue to step 208 to determine whether the user is frustrated. If the augmented reality assistance program 110A, 110B determines that the amount of time that the monitored user is spending on the step does not exceed the average amount of time spent on this step, with respect to the user's past performance on similar steps and/or with respect to the amount of time spent by other users on this step or similar steps (step 206, “NO” branch), the augmented reality assistance program 110A, 110B may continue to step 202 to monitor audio and visual data from a user who is employing an augmented reality device.

At 208, the augmented reality assistance program 110A, 110B determines whether the user is frustrated. The augmented reality assistance program 110A, 110B may determine whether a user is frustrated by searching the audio and visual data for contextual clues in the user's speech, behavior, environment, et cetera, that may indicate stress, herein referred to as stress factors. For example, user behavior such as violent movements, angry or rude gestures, trying to force a part into another part, doing something irrational such as hammering or throwing an object when such is not called for in a step, flipping back and forth in the instructions, repeating a step over and over, et cetera may indicate stress. A user's speech may also indicate stress, such as where the user is shouting, muttering, producing angry or pained sounds, voicing anger or confusion, speaking in a belligerent tone, et cetera. In some embodiments, augmented reality assistance program 110A, 110B may consult other information besides the audio and visual data to identify stress factors. For example, in embodiments where the user is wearing a vitality tracker, augmented reality assistance program 110A, 110B may measure the user's heart rate to infer stress levels.

In some embodiments, the augmented reality assistance program 110A, 110B may weight each stress factor according to the severity of the frustration it implies. For example, the user muttering may indicate low frustration and be given a low weight, while a user violently jamming a part against another part where the steps do not call for such action may indicate high frustration, and may be weighted heavily. In some embodiments, augmented reality assistance program 110A, 110B may assess levels of frustration, which may indicate how frustrated a user is, and may inform the number or scope of actions that may be necessary to alleviate the frustration and/or assist the user in completing the step. A user may reach a given level of frustration when the combined number of stress factors and/or combined weights of each stress factor exceeds a threshold value. The threshold value may be unique to the user or may be generally applied to all or a subset of users, and may be calculated based on individual or collective user information, the success of past support actions in alleviating frustration and/or completing the task, past accuracy of weighted stress factors in determining frustration, et cetera. In some embodiments, high levels of frustration may be identified as anger.

In some embodiments of the invention, the augmented reality assistance program 110A, 110B may further infer the sources of the user's frustration. The augmented reality assistance program 110A, 110B may gather information on the user's environment which may produce stress, such as the presence of loud or disruptive background noise, other people speaking or addressing the user repeatedly, children or animals running around, television sets being on, whether objects required by the step are hard to reach or contain a dangerous condition (such as hot surfaces, splintery fiberglass, sharp protrusions), the presence of stressful weather conditions or uncomfortably hot or low temperatures near the user, et cetera. The augmented reality assistance program 110A, 110B may further consult user information that may imply sources of stress, such as age, familiarity with the task as evidenced by profession or tasks the user has previously performed, whether the user has shown frustration on past steps and/or the similarity of those steps, whether the user is right- or left-handed and whether the current step favors a particular hand, et cetera. In some embodiments augmented reality assistance program 110A, 110B may use speech processing techniques to recognize the speech of the user, and derive meaning from the user's words; this meaning may be analyzed to interpret the source of the user's frustration. The augmented reality assistance program 110A, 110B may distinguish whether the source of frustration is largely an environmental or contextual factor, or whether the source of frustration is the step itself. For example, where a step requires a user to disconnect a battery to change a steering wheel on a hot day, augmented reality assistance program 110A, 110B may determine whether the user is primarily frustrated because the car is hot, or because the user is upset that the step requires the user to disconnect the battery to change the steering wheel, for instance by using speech processing to identify that the user is complaining about the heat. In some embodiments, the augmented reality assistance program 110A, 110B may explicitly ask the user, either through synthesized or recorded speech or through visual prompts on a display, questions designed to reveal what is frustrating the user.

According to one implementation, if the augmented reality assistance program 110A, 110B determines that the number and/or combined weight of the stress factors exceeds a threshold value indicating the amount of stress that indicates at least a minimum amount of frustration in the user (step 208, “YES” branch), the augmented reality assistance program 110A, 110B may continue to step 210 to modify the augmented reality environment to calm the user. If the augmented reality assistance program 110A, 110B determines that the number and/or combined weight of the stress factors does not exceed a threshold value indicating the amount of stress that indicates at least a minimum amount of frustration in the user (step 208, “NO” branch), the augmented reality assistance program 110A, 110B may continue to step 212 to determine whether the user is confused.

At 210, the augmented reality assistance program 110A, 110B may perform an action to reduce user frustration. For example, the augmented reality assistance program 110A, 110B may adjust the color of visual elements within the augmented reality environment displayed to the user to cooler, more calming colors. The augmented reality assistance program 110A, 110B may change audio feedback, such as computer-generated speech, to softer, more personal tones as opposed to confident instructive tones, and/or may change the speech to be more friendly (for instance, “please remove part A” instead of “remove part A”). The augmented reality assistance program 110A, 110B may try to inject humor through comments or visual elements on the AR display, and/or make comments in solidarity (“it's not your fault, this step is really hard, a lot of people have trouble with it and we're trying to improve it”).

In some embodiments, for example where augmented reality assistance program 110A, 110B assesses levels of frustration, augmented reality assistance program 110A, 110B may perform different actions depending on the severity of the stress level. For example, at low levels of stress, augmented reality assistance program 110A, 110B may make subtler changes to calm the user, such as changing colors or changing/adding visual elements (e.g. an amusing cartoon character) to the AR environment to calm the user or add humor, changing the voice of the AR system to be more calming, et cetera. At middling levels of frustration, the augmented reality assistance program 110A, 110B may, for example, add or switch to more direct measures, such as providing context for the instructions, making humorous or empathetic statements, making suggestions to make the user more comfortable, et cetera. At the highest levels of frustration, the augmented reality assistance program 110A, 110B may, for example, suggest that the user take a break, attempt to empathize with the user by acknowledging the user's frustration and the difficulty of the task, or in some embodiments may attempt to expedite transfer of the user to a live agent for assistance, for example my moving directly to step 216 to infer elements of a step that are causing trouble for a user.

In some embodiments, for example where augmented reality assistance program 110A, 110B assesses the sources of frustration of a user, augmented reality assistance program 110A, 110B may make suggestions tailored to a source of the frustration of the user. For example, if the user is frustrated in part because she is uncomfortable, the augmented reality assistance program 110A, 110B may make suggestions to make the user more comfortable. For example, if the ambient temperature is hot, the augmented reality assistance program 110A, 110B may suggest that the user take a break and cool down, or adjust the temperature in the room. If the user is frustrated based on position of the user or objects, the augmented reality assistance program 110A, 110B may suggest a tool that simplifies the task based on the constraints. If the user is frustrated at least in part because they do not understand the reason for a step or for an action of the step, augmented reality assistance program 110A, 110B may explain the context for the step or action and/or the reason that it is necessary. In some embodiments, such as where augmented reality assistance program 110A, 110B assesses levels of frustration, augmented reality assistance program 110A, 110B may favor making suggestions tailored to the sources of frustration of the user when the user is at high levels of frustration, as the frustrated user may become even more frustrated if he does not feel heard or like his particular need is being addressed.

While the present embodiment illustrated in FIG. 2 depicts augmented reality assistance program 110A, 110B repeatedly performing actions to reduce user frustration until the user is no longer frustrated, before proceeding on to determine whether the user is confused and, upon a positive determination of confusion, performing support actions to assist the user, one of ordinary skill in the art would understand that embodiments of the invention may perform any number and combination of actions to reduce frustration and/or support actions to assist the user after making the determination that the user is frustrated, and in some embodiments may not make a determination as to whether a user is confused if the user has previously been determined to be frustrated.

At 212, the augmented reality assistance program 110A, 110B determines whether the user is confused. The augmented reality assistance program 110A, 110B may detect confusion by searching the audio and visual data for contextual clues in the user's speech, behavior, environment, et cetera, that may indicate confusion, herein referred to as confusion factors. For example, if the user is looking at instructions for a long time, interacting with or looking at an object which does not pertain to a step or pertains to a different step than the current step, attempting an action repeatedly, performing an action that does not pertain to the step, or otherwise exhibiting behaviors that indicate confusion and/or are unrelated to the successful completion of the step. In some embodiments, augmented reality assistance program 110A, 110B may take into account stress factors in determining confusion; if augmented reality assistance program 110A, 110B determines that the user is not frustrated, user behaviors that may otherwise indicate stress, such as muttering, flipping back and forth between instructions, attempting the same step over and over again, et cetera, may indicate confusion. In some embodiments, augmented reality assistance program 110A, 110B may weigh the confusion factors according to the severity of the confusion they indicate. The augmented reality assistance program 110A, 110B may determine that a user is confused if the combined total and/or weight of the confusion factors exceeds a threshold value.

In some embodiments, augmented reality assistance program 110A, 110B may infer the source of the user's confusion; the augmented reality assistance program 110A, 110B may gather information on the user's behaviors and identify whether the user is evidencing confusion with respect to particular instructions, actions, objects, et cetera. The augmented reality assistance program 110A, 110B may further assess the user's environment for conditions that might distract or disorient the user, such as the presence of loud or disruptive background noise, other people speaking or addressing the user repeatedly, children or animals running around, television sets being on, screens in the background, the presence of distracting weather conditions, et cetera. The augmented reality assistance program 110A, 110B may further consult user information that may imply sources of confusion, such as age, familiarity with the task as evidenced by the user's profession or tasks the user has previously performed, et cetera.

According to one implementation, if the augmented reality assistance program 110A, 110B determines that the user is confused (step 212, “YES” branch), the augmented reality assistance program 110A, 110B may continue to step 214 to perform or offer to perform one or more support actions to assist the user. If the augmented reality assistance program 110A, 110B determines that the user is not confused (step 212, “NO” branch), the augmented reality assistance program 110A, 110B may continue to step 202 to monitor audio and visual data from a user who is employing an augmented reality device.

At 214, augmented reality assistance program 110A, 110B may perform one or more support actions to assist the user. In some embodiments, the augmented reality assistance program 110A, 110B may simply elaborate on the instructions for the step that the user is currently stuck on, and/or explain its relationship to the next step. In some embodiments, for example if the user was previously frustrated or still is frustrated, augmented reality assistance program 110A, 110B may break down the step into easier, less complex instructions. In some embodiments, augmented reality assistance program 110A, 110B may make suggestions based on the actions of the user. For example, if the user is looking at or interacting with an object that is necessary in another step, augmented reality assistance program 110A, 110B may gently remind the user that the part is used in a future or previous step. In some embodiments, such as where the user's confusion may be attributable to distractions in the environment, the augmented reality assistance program 110A, 110B may suggest that the user move to a different location or take action to reduce the distractions.

In some embodiments, such as where augmented reality assistance program 110A, 110B assesses levels of frustration, augmented reality assistance program 110A, 110B may favor taking actions tailored to address the sources of frustration of the user when the user is at high levels of frustration, as the frustrated user may become even more frustrated if he does not feel heard or like his particular need is being addressed. For example, in embodiments where augmented reality assistance program 110A, 110B detects a low level of frustration, augmented reality assistance program 110A, 110B may suggest a short break while it reaches out to a support for a suggestion on how to move forward; the augmented reality assistance program 110A, 110B may collect the context/background and reach out asynchronously to an automated knowledge system or set of support agents for a quick text/voice/video suggestion tailored to exactly what the user is stuck on. In some embodiments, for instance where augmented reality assistance program 110A, 110B detects high levels of frustration, augmented reality assistance program 110A, 110B may, for example, use some empathy techniques and proactively tell the user something to disarm the situation with humor and/or empathy, such as, “hey I know you're really frustrated with this right now, but before you throw this part through the window, we're going to get an expert on the line”. The augmented reality assistance program 110A, 110B may try to connect to a live agent and give the expert the exact step/context/background needed to hopefully resolve the frustration very quickly.

At 216, the augmented reality assistance program 110A, 110B may infer elements of a step that are causing trouble for the user. In some embodiments, such as where the augmented reality assistance program 110A, 110B infers the source of the user's confusion and/or frustration, augmented reality assistance program 110A, 110B may identify whether any of the previously identified sources of confusion and/or anger are or pertain to the steps or elements of the steps; for example, whether any of the confusion and/or frustration is the result of the instructions explaining the steps, the tools/hardware used in the steps, individual actions within the steps, et cetera. The augmented reality assistance program 110A, 110B may consider any elements of the step that have been the sources of confusion or frustration for the user to be trouble elements.

At 218, the augmented reality assistance program 110A, 110B may record the user's trouble elements and visual elements pertaining to the completed steps. The augmented reality assistance program 110A, 110B may record the elements of the step that have been inferred to be causing trouble for the user, along with visual elements pertaining to the completed steps; visual elements pertaining to the completed steps may include display elements overlaid onto the augmented reality environment of the user, or the camera feed from the user's augmented reality device 118, that can visually indicate to a support agent which steps have been completed. In some embodiments, to the extent possible, augmented reality assistance program 110A, 110B may visually indicate the elements of the step that have been inferred to cause trouble for the user, such as, for example, highlighting the part that the user needs to place on a device, and the location on the device where the user has been incorrectly attempting to attach the part, and/or highlighting the specific instruction that the user has been reading repeatedly. The trouble elements may be visually highlighted in a different color than other visual AR elements to better stand out.

At 220, the augmented reality assistance program 110A, 110B may notify a support agent of the user's trouble elements and the current completion status of the task. The augmented reality assistance program 110A, 110B may communicate the step that the user is currently on, which steps have been completed, and/or the particular elements of the step that have caused the user confusion and/or frustration, such that the user does not need to educate the support agent on the situation. In some embodiments, augmented reality assistance program 110A, 110B may communicate the emotional status of the user to the support agent, and in some embodiments may indicate to the support agent which actions attempted by augmented reality assistance program 110A, 110B have raised or lowered the user's frustration or confusion.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the augmented reality program 108 and the augmented reality assistance program 110A in the client computing device 102, and the augmented reality assistance program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the augmented reality assistance program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The augmented reality program 108 and the augmented reality assistance program 110A in the client computing device 102 and the augmented reality assistance program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the augmented reality program 108 and the augmented reality assistance program 110A in the client computing device 102 and the augmented reality assistance program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

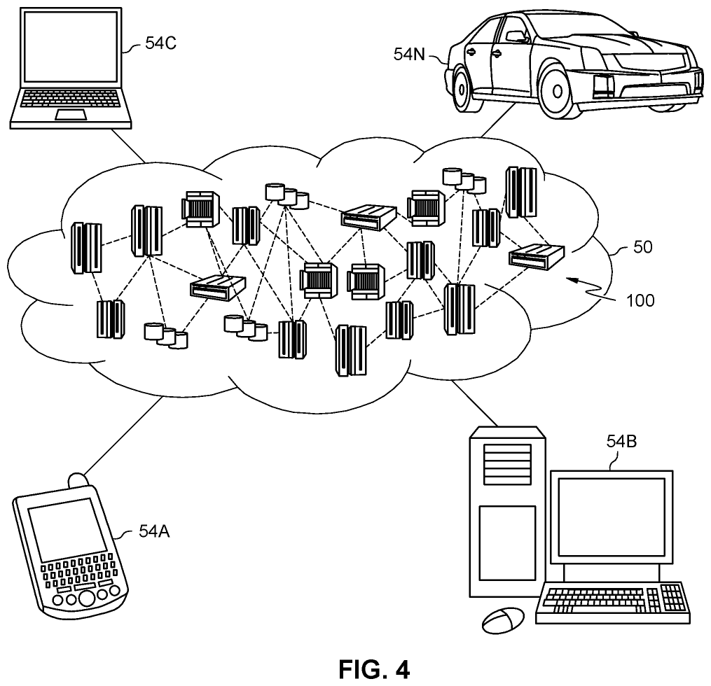

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

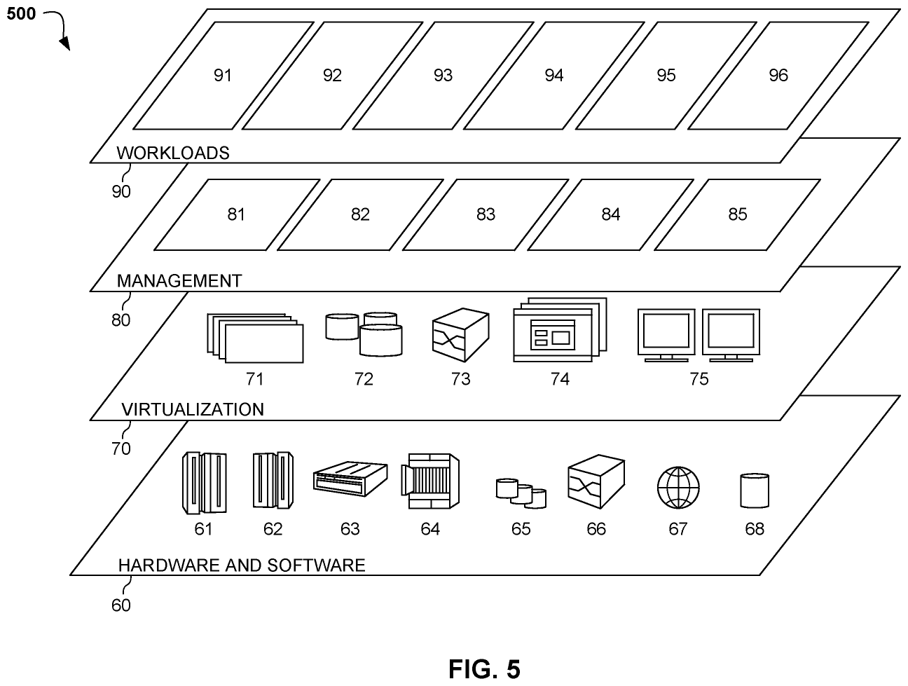

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and augmented reality assistance 96. Augmented reality assistance 96 may relate to utilizing audio and visual data from an augmented reality system to assess the emotional condition of the user, the user's current progress in executing a task, the reasons for the user's difficulty, and formulate an appropriate support response.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A processor-implemented method for providing support to a user within an augmented reality environment based on an emotional state of the user, the method comprising:
based on data gathered from an augmented reality device, determining a step of a series of steps the user is currently performing;
based at least in part on data gathered from the augmented reality device, identifying a stress level and a confusion level of the user;
responsive to determining that the stress level of the user exceeds a stress threshold, performing one or more actions to reduce the stress level of the user to at or below the stress threshold; and
responsive to determining that the confusion level of the user exceeds a confusion threshold and the stress level of the user meets or falls below the stress threshold, performing one or more support actions pertaining to the currently performed step to reduce the confusion level of the user.

2. The method of claim 1, wherein the one or more support actions are based on one or more sources of one or more confusion factors comprising the confusion level of the user.

3. The method of claim 1, wherein the one or more actions to reduce the stress level of the user are based on one or more sources of one or more stress factors comprising the user's stress level.

4. The method of claim 1, wherein the one or more actions to reduce the stress level of the user or the one or more support actions are based on determining whether one or more sources of one or more stress factors comprising the stress level or one or more confusion factors comprising the confusion level, respectively, are environmental or related to the step.

5. The method of claim 1, wherein determining the step that the user is currently performing is based on determining that one or more steps of the series of steps have not been completed.

6. The method of claim 1, wherein a plurality of threshold values, representing a plurality of levels of frustration of the user, are associated with the stress level, and the one or more actions to reduce the stress level of the user are based on the level of frustration of the user.

7. The method of claim 1, responsive to determining that one or more elements of the step are sources of one or more stress factors or one or more confusion factors respectively comprising the user's stress level or confusion level, communicating the one or more elements to a support agent with one or more visual elements within the augmented reality environment.

8. A computer system for providing support to a user based on an emotional state of the user within an augmented reality environment, the computer system comprising:
one or more augmented reality devices, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
based on data gathered from an augmented reality device, determining a step of a series of steps the user is currently performing;
based at least in part on data gathered from the augmented reality device, identifying a stress level and a confusion level of the user;
responsive to determining that the stress level of the user exceeds a stress threshold, performing one or more actions to reduce the stress level of the user to at or below the stress threshold; and
responsive to determining that the confusion level of the user exceeds a confusion threshold and the stress level of the user meets or falls below the stress threshold, performing one or more support actions pertaining to the currently performed step to reduce the confusion level of the user.

9. The computer system of claim 8, wherein the one or more support actions are based on one or more sources of one or more confusion factors comprising the confusion level of the user.

10. The computer system of claim 8, wherein the one or more actions to reduce the stress level of the user are based on one or more sources of one or more stress factors comprising the user's stress level.

11. The computer system of claim 8, wherein the one or more actions to reduce the stress level of the user or the one or more support actions are based on determining whether one or more sources of one or more stress factors comprising the stress level or one or more confusion factors comprising the confusion level, respectively, are environmental or related to the step.

12. The computer system of claim 8, wherein determining the step that the user is currently performing is based on determining that one or more steps of the series of steps have not been completed.

13. The computer system of claim 8, wherein a plurality of threshold values, representing a plurality of levels of frustration of the user, are associated with the stress level, and the one or more actions to reduce the stress level of the user are based on the level of frustration of the user.

14. The computer system of claim 8, responsive to determining that one or more elements of the step are sources of one or more stress factors or one or more confusion factors respectively comprising the user's stress level or confusion level, communicating the one or more elements to a support agent with one or more visual elements within the augmented reality environment.

15. A computer program product for providing support to a user based on an emotional state of the user within an augmented reality environment, the computer program product comprising:
one or more computer-readable tangible storage medium and program instructions stored on at least one of the one or more tangible storage medium, the program instructions executable by a processor to cause the processor to perform a method comprising:
based on data gathered from an augmented reality device, determining a step of a series of steps the user is currently performing;
based at least in part on data gathered from the augmented reality device, identifying a stress level and a confusion level of the user;
responsive to determining that the stress level of the user exceeds a stress threshold, performing one or more actions to reduce the stress level of the user to at or below the stress threshold; and
responsive to determining that the confusion level of the user exceeds a confusion threshold and the stress level of the user meets or falls below the stress threshold, performing one or more support actions pertaining to the currently performed step to reduce the confusion level of the user.

16. The computer program product of claim 15, wherein the one or more support actions are based on one or more sources of one or more confusion factors comprising the confusion level of the user.

17. The computer program product of claim 15, wherein the one or more actions to reduce the stress level of the user are based on one or more sources of one or more stress factors comprising the user's stress level.

18. The computer program product of claim 15, wherein the one or more actions to reduce the stress level of the user or the one or more support actions are based on determining whether one or more sources of one or more stress factors comprising the stress level or one or more confusion factors comprising the confusion level, respectively, are environmental or related to the step.

19. The computer program product of claim 15, wherein determining the step that the user is currently performing is based on determining that one or more steps of the series of steps have not been completed.

20. The computer program product of claim 15, wherein a plurality of threshold values, representing a plurality of levels of frustration of the user, are associated with the stress level, and the one or more actions to reduce the stress level of the user are based on the level of frustration of the user.
